(19) United States
(12) Patent Application Publication
(10) Pub. No.: US 2015/0249861 A1
(43) Pub. Date: Sep. 3, 2015

(54) BROADCASTING SIGNAL RECEIVING APPARATUS AND CONTROL METHOD OF THE SAME

(71) Applicant: SAMSUNG ELECTRONICS CO., LTD., Suwon-si (KR)

(72) Inventors: Ki-suk KIM, Suwon-si (KR); Hee-beom KANG, Suwon-si (KR); Hyeoung-ki KIM, Seoul (KR); Ho-shin SON, Hwaseong-si (KR); Jung-yeon WOO, Seoul (KR); Woo-sung CHUNG, Seongnam-si (KR); Yun-ho CHOI, Seoul (KR)

(73) Assignee: SAMSUNG ELECTRONICS CO., LTD., Suwon-si (KR)

(21) Appl. No.: 14/625,713

(22) Filed: Feb. 19, 2015

(30) Foreign Application Priority Data
Feb. 28, 2014 (KR) 10-2014-0024076

(51) Int. Cl. H04N 21/44; H04N 21/434; H04N 21/426; H04N 21/433; H04N 21/4147

(52) U.S. Cl. CPC H04N 21/44004; H04N 21/4334; H04N 21/4147; H04N 21/42615; H04N 21/434

(57) ABSTRACT

A broadcasting signal receiving apparatus a method of controlling the same are provided. The broadcasting signal receiving apparatus includes: a signal receiver configured to receive a broadcasting signal including a stream of data for displaying an image; a buffer configured to store the stream; an interface configured to interface the buffer and a storage device including a storage space for reproducing the stream; a controller configured to control the interface to receive storage information about the stream from the buffer, to receive the stream from the buffer based on the received storage information, and to store the stream in the storage device.

### CROSS-REFERENCE TO RELATED APPLICATION

This application claims priority from Korean Patent Application No. 10-2014-0024076, filed on Feb. 28, 2014 in the Korean Intellectual Property Office, the disclosure of which is incorporated herein by reference in its entirety.

### BACKGROUND

1. Field

Apparatuses and methods consistent with exemplary embodiments relate to a broadcasting signal receiving apparatus and a control method of the same, and more particularly to a broadcasting signal receiving apparatus for storing a stream of a broadcasting signal and a control method of the same.

2. Description of the Related Art

In a technology of recording and reproducing a stream included in a broadcasting signal, a tuner receives the broadcasting signal and differentially extracts video data and audio data from the received broadcasting signal. The extracted video and audio data are converted to the form of a stream and stored in a storage space. The stored streams are sent to video and audio decoders, converted into signals for display, and then displayed.

In the related art, a stream data buffer has been used to convert the extracted video and audio data into the form of the stream and then to send the stream to the storage space. To this end, a separate processing process is disadvantageously needed to control a flow for assigning and using a buffer. Further, there arises a problem that additional loads are caused by previous indexing, formatting with attached additional information, or the like processing process in order to store the stream.

### SUMMARY

Aspects of one or more exemplary embodiments provide a broadcasting signal receiving apparatus and a control method of the same, which can store a stream of a received broadcasting signal in a buffering section, and control an interface section so that the stored stream can be received based on the storage information received from the buffering section and stored in a storage device, thereby storing the stream of the broadcasting signal through simplified processes.

According to an aspect of an exemplary embodiment, there is provided a broadcasting signal receiving apparatus including: a signal receiver configured to receive a broadcasting signal including a stream of data for displaying an image; a buffer configured to store the stream included in the received broadcasting signal; an interface configured to interface the buffer and a storage device including a storage space for reproducing the stream; and a controller configured to control the interface to receive, from the buffer, storage information about the stored stream, to receive, from the buffer, the stored stream based on the received storage information, and to store the received stream in the storage device. Thus, it is possible to provide an efficient system where a memory space needed for storing a stream is minimized, and a simple algorithm is used for storing a stream of a broadcasting signal.

The storage information may include at least one of a size of the stream stored in the buffer and a storing location of the stream stored in the buffer. Thus, it is possible to quickly and effectively store the stream of the broadcasting signal based on information about a stream size and a storing location.

The controller may include at least portions of a transport stream demultiplexer (TSD) application and a personal video recorder (PVR) application. Thus, it is possible to control the interface to effectively store a stream of a broadcasting signal by executing a transport stream decoder (TSD) application and a personal video recorder (PVR) application.

The buffer may be configured to store the stream of the received broadcasting signal in real time. Thus, it is possible to quickly store the stream of the broadcasting signal that is being reproduced.

The buffer may be set to have a variable size. Thus, it is possible to optimally set up a buffer size in consideration of the number of broadcasting channels, the type and capacity of the received broadcasting signal, etc.

The controller may be configured to control the interface to receive the stream stored in the buffer in response to predetermined units of the stream being completely stored in the buffer. Thus, it is possible to quickly receive the stream of the broadcasting signal that is being stored in the buffer.

The interface may be configured to interface with the storage device according to at least one of universal serial bus (USB), serial advanced technology attachment (SATA), and peripheral component interconnect-express (PCIe). Thus, there is provided an interface for exchanging data between an external storage device and an internal buffer.

The controller may be configured to convert the stream stored in the storage device and to store the converted stream.

The controller may be configured to extract an index from the stream stored in the storage device, and to store the index-extracted stream. Thus, it is possible to reduce an additional load and efficiently store a stream, while a broadcasting program being viewed is recorded.

The buffer may be configured to store a plurality of streams of the received broadcasting signal in accordance with a plurality of channels, respectively. Thus, it is possible to simultaneously store the streams of the broadcasting signals with regard to the plurality of channels.

According to an aspect of another exemplary embodiment, there is provided a method of controlling a broadcasting signal receiving apparatus, the method including: receiving a broadcasting signal including a stream of data for displaying an image; storing, in a buffer, the stream included in the received broadcasting signal; receiving, from the buffer, storage information about the stored stream; receiving, from the buffer, the stored stream based on the received storage information; and storing the received stream in a storage device. Thus, it is possible to provide an efficient system where a memory space needed for storing a stream is minimized, and a simple algorithm is used for storing a stream of a broadcasting signal.

The storage information may include at least one of a size of the stream stored in the buffer and a storing location of the stream stored in the buffer. Thus, it is possible to quickly and effectively store the stream of the broadcasting signal based on information about a stream size and a storing location.

The storing the received stream in the storage device may include storing, by at least portions of a transport stream demultiplexer (TSD) application and a personal video recorder (PVR) application, the received stream in the storage device. Thus, it is possible to control the interface to effectively store a stream of a broadcasting signal by executing a transport stream decoder (TSD) application and a personal video recorder (PVR) application.

The storing the stream in the buffer may include storing the stream of the received broadcasting signal in real time. Thus, it is possible to quickly store the stream of the broadcasting signal that is being reproduced.

The buffer may be set to have a variable size. Thus, it is possible to optimally set up a buffer size in consideration of the number of broadcasting channels, the type and capacity of the received broadcasting signal, etc.

The receiving the stored stream may include receiving, from the buffer, the stored stream in response to predetermined units of the stream being completely stored in the buffer. Thus, it is possible to quickly receive the stream of the broadcasting signal that is being stored in the buffer.

The storing the received stream in the storage device may include interfacing with the storage device according to at least one of universal serial bus (USB), serial advanced technology attachment (SATA), and peripheral component interconnect-express (PCIe). Thus, there is provided an interface for exchanging data between an external storage device and an internal buffer.

The method may further include converting the stream stored in the storage device and storing, in the storage device, the converted stream.

The method may further include extracting an index from the stream stored in the storage device, and storing, in the storage device, the index-extracted stream. Thus, it is possible to reduce an additional load and efficiently store a stream, while a broadcasting program being viewed is recorded.

The method may further include storing a plurality of streams of the received broadcasting signal in accordance with a plurality of channels, respectively. Thus, it is possible to simultaneously store the streams of the broadcasting signals with regard to the plurality of channels.

According to an aspect of another exemplary embodiment, there is provided a non-transitory computer readable recording medium having recorded thereon a program executable by a computer for performing the method.

According to an aspect of another exemplary embodiment, there is provided a broadcasting signal receiving apparatus including: a signal receiver configured to receive a broadcasting signal including a stream of data for displaying an image; a buffer configured to store the stream included in the received broadcasting signal; and a controller configured to control receiving, from the buffer, storage information about the stored stream, receiving, from the buffer, the stored stream based on the received storage information, and storing the received stream in the storage device.

The storage information may include at least one of a size of the stream stored in the buffer and a storing location of the stream stored in the buffer.

The controller may include at least portions of a transport stream demultiplexer (TSD) application and a personal video recorder (PVR) application.

The buffer may be configured to store the stream of the received broadcasting signal in real time.

The buffer may be set to have a variable size.

The controller may be configured to control receiving the stream stored in the buffer in response to predetermined units of the stream being completely stored in the buffer.

The controller may be configured to convert the stream stored in the storage device and to store the converted stream.

The controller may be configured to extract an index from the stream stored in the storage device, and to store the index-extracted stream.

The buffer may be configured to store a plurality of streams of the received broadcasting signal in accordance with a plurality of channels, respectively.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a broadcasting signal receiving apparatus according to an exemplary embodiment;

FIG. 2 shows an example in which an interface section receives a stream from a buffer and stores the stream in a storage device, based on storage information received from the buffer according to an exemplary embodiment;

FIG. 3 shows an example in which the stream stored in the buffer according to an exemplary embodiment is received and stored in the storage device;

FIG. 4 shows an example in which the stream is stored in the storage device according to an exemplary embodiment;

FIG. 5 is a block diagram of a broadcasting signal receiving apparatus according to an exemplary embodiment; and

FIG. 6 is a flowchart showing a method of controlling the broadcasting signal receiving apparatus according to an exemplary embodiment.

### DETAILED DESCRIPTION OF EXEMPLARY EMBODIMENTS

Hereinafter, exemplary embodiments will be described in detail with reference to accompanying drawings so as to be easily realized by a person having an ordinary skill in the art, but not limited to the following embodiments set forth herein. Descriptions about unrelated parts are omitted for clarity, and like numbers refer to like elements throughout. Expressions such as “at least one of,” when preceding a list of elements, modify the entire list of elements and do not modify the individual elements of the list.

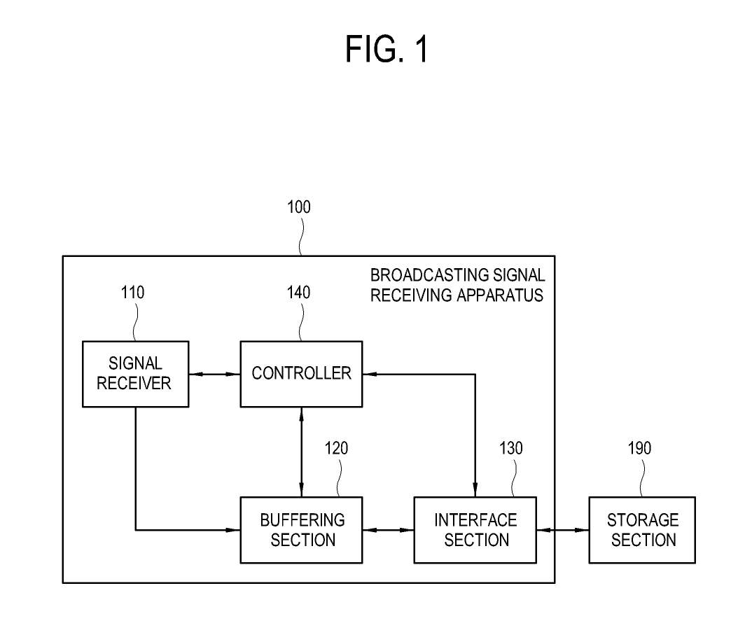

Hereinafter, elements of a broadcasting signal receiving apparatus according to one or more exemplary embodiments will first be described in detail with reference to FIG. 1 and FIGS. 2 to 4 as necessary. FIG. 1 is a block diagram showing a broadcasting single receiving apparatus 100 according to an exemplary embodiment. As shown in FIG. 1, the broadcasting signal receiving apparatus 100 includes a signal receiver 110, a buffering section 120 (e.g., buffer), an interface section 130 (e.g., interface), and a controller 140, and connects with a storage device 190 (e.g., storage or storage section). The broadcasting signal receiving apparatus 100 may for example be achieved by or implemented as a personal video recorder (PVR), a television (TV), a personal computer (PC), a notebook computer, a tablet, or the like capable of recording a broadcast corresponding to a predetermined period of time. The storage device 190 may for example be achieved by a hard disk drive (HDD), a universal serial bus (USB) memory, etc. While in the present exemplary embodiment, the storage device 190 is external to the broadcasting signal receiving apparatus 100, it is understood that one or more other exemplary embodiments are not limited thereto. For example, according to another exemplary embodiment, the storage device 190 may be included in the broadcasting signal receiving apparatus 100.

The broadcasting signal receiving apparatus 100 receives a broadcasting signal including a stream of data for displaying an image, and stores the stream of data included in the received broadcasting signal in the buffering section 120.

The broadcasting signal receiving apparatus 100 receives storage information about the stream from the buffering section 120, receives the stream from the buffering section 120, and stores the stream in the storage device 190 based on the received storage information. Thus, the broadcasting signal receiving apparatus 100 according to an exemplary embodiment provides a system efficient in minimizing a memory space to store a stream and in storing a stream of a broadcasting signal by a simple algorithm since a separate processing process is not needed to store the stream in a buffer and subsequently receive and store the stored stream in the storage device.

The signal receiver 110 receives a broadcasting signal including a stream of data to display an image. The signal receiver 110 may be provided in various forms in accordance with, for example, various standards of broadcasting signals and types of the broadcasting signal receiving apparatus 100. For example, the signal receiver 110 may be achieved by or implemented as a tuner for receiving a radio frequency (RF) broadcasting signal transmitted from a broadcasting station.

The buffering section 120 (e.g., a buffer included in a storage device) stores a stream of a broadcasting signal received in the signal receiver 110. The stream stored in the buffering section 120 may be achieved by storing a stream of a received broadcasting signal in real time. That is, the stream stored in the buffering section 120 may be stored at the same speed as the receiving speed of the stream of the broadcasting signal actually received in the signal receiver 110. The size of the buffering section 120 may be set to be changeable. For example, the size of the buffering section 120 may be set in consideration of at least one of the number of broadcasting channels receivable in the broadcasting signal receiving apparatus 100, the format and size of the broadcasting signal, etc. The buffering section 120 may store the stream of the received broadcasting signal according to a plurality of channels. According to an exemplary embodiment, buffers may be respectively assigned to channels in order to store a broadcasting signal according to a plurality of channels.

The interface section 130 interfaces the buffering section 120 and the storage device 190 (e.g., nonvolatile storage) having a storage space for reproducing the stream. The interface section 130 may interface with the storage device 190 according to at least one of USB, serial advanced technology attachment (SATA), and peripheral component interconnect-express (PCIe). For example, the interface section 130 may use an interface of Universal Serial Bus (USB) port standards to exchange data between the internal buffering section 120 and the external storage device 190 such as a hard disk drive (HDD), a USB memory, etc.

The controller 140 controls the interface section 130 to receive storage information about a stream from the buffering section 120, receive the stream from the buffering section 120 based on the received storage information, and store the received stream in the storage device 190. The storage information may include at least one of the size and the storing location of the stream stored in the buffering section 120.

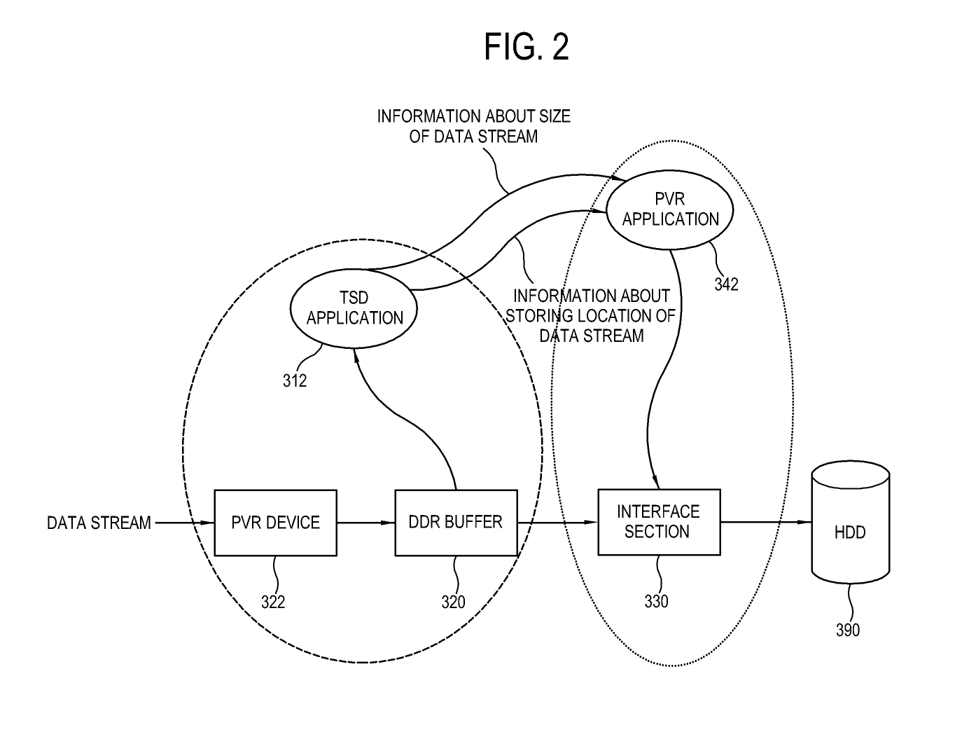

The controller 140 may include a transport stream demultiplexer (TSD) application 312 and a PVR application 342. As shown in FIG. 2, the TSD application 312 and the PVR application 342 may implement the operations of the controller 140 shown in FIG. 1. An interface section 330 shown in FIG. 2 is an example of the interface section 130 shown in FIG. 1. Further, a PVR device 322, a double data rate (DDR) buffer 320 and, and a HDD 390 shown in FIG. 2 are examples of the signal receiver 110, the buffering section 120, and the storage device 190 of FIG. 1. As shown in FIG. 2, the TSD application 312 may control the storage information about the stream stored in the DDR buffer 320 to be transmitted to the PVR application 342 in response to a request from the PVR application 342. Further, the PVR application 342 may control the storage information about the stream received from the TSD application 312 to be transmitted to the interface section 330 so that the interface section 330 can receive the stream from the DDR buffer 320 and store the stream in the HDD 390. Thus, the controller 140 may include and implement the TSD application 312 and the PVR application 342 so that the interface section 130 can be controlled to store the stream in the storage device 190 based on the storage information about the stream received from the buffering section 120.

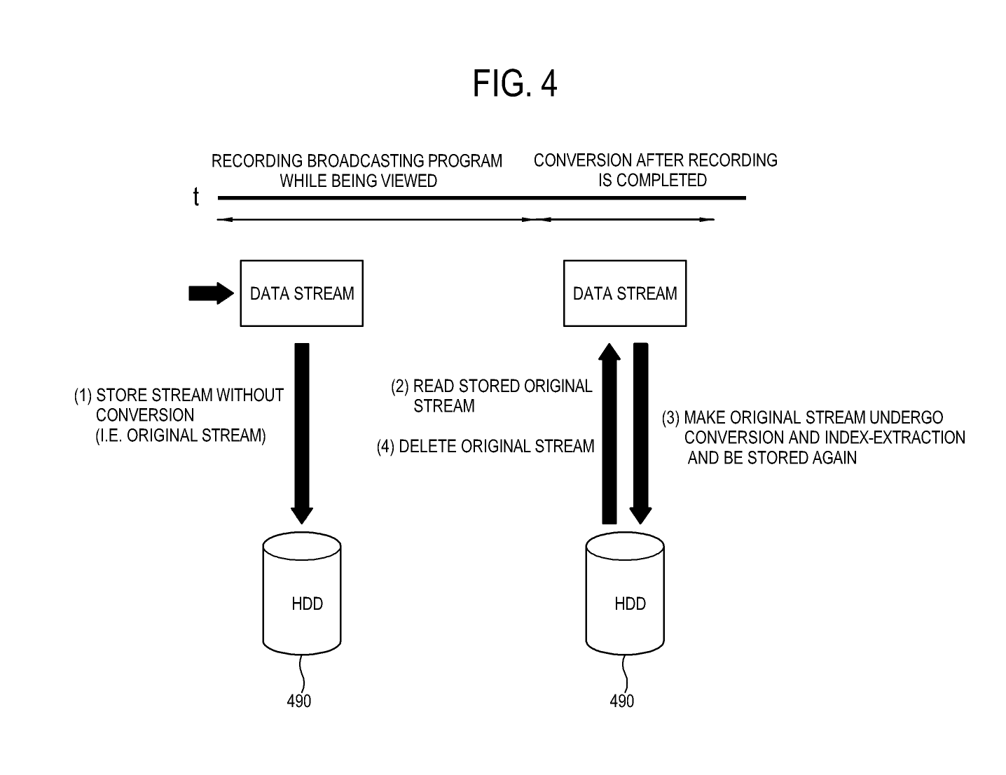

The controller 140 may convert the stream stored in the storage device 190 and store the converted stream again in the storage device 190. Further, the controller 140 may extract an index from the stream stored in the storage device 190 and store the stream again in the storage device 190. According to an exemplary embodiment, as shown in FIG. 4, when a broadcasting program is recorded while being viewed, the controller 140 stores the stream of the broadcasting signal in the HDD 490 without an indexing process. When the broadcasting program is ended and completely recorded, the controller 140 immediately converts the stored stream to have a format in which additional information is attached or included, and stores the converted stream again in the HDD 490. Further, the controller 140 may extract an index from the stream stored in the HDD 490 and store the stream again in the HDD 490.

FIG. 2 shows an example in which an interface section receives a stream from a buffer and stores the stream in a storage device, based on storage information received from the buffer according to an exemplary embodiment. As shown in FIG. 2, the PVR device 322 receives a broadcasting stream and stores it in the DDR buffer 320, and the TSD application 312 controls the storage information about the size, the storing location, etc. of the data stream stored in the DDR buffer 320 to be transmitted to the PVR application 342 in response to a request from the PVR application 342. The PVR application 342 transmits the storage information about the stream received from the TSD application 312 to the interface section 330 so that the interface section 330 can receive a broadcasting stream from the DDR buffer 320 and store it in the HDD 390.

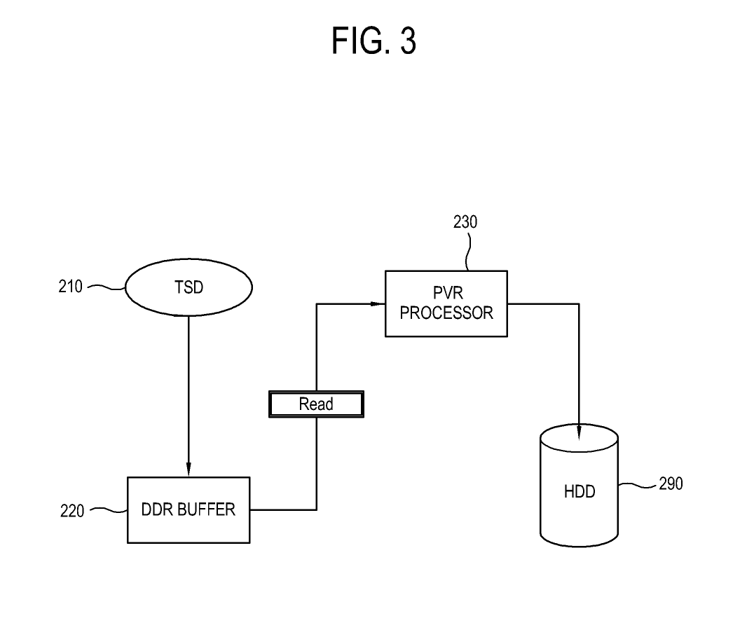

Below, an exemplary embodiment of FIG. 3 will be described as an alternative to the exemplary embodiments of FIG. 1 and FIG. 2. FIG. 3 shows an example in which the stream stored in the buffer according to an exemplary embodiment is received and stored in the storage device. A TSD 210 shown in FIG. 3 corresponds to the signal receiver 110 of FIG. 1 and the PVR device 322 of FIG. 3. Further, a DDR buffer 220 and a HDD 290 shown in FIG. 3 respectively correspond to the buffering section 120 and the storage device 190 of FIG. 1, and also correspond to the DDR buffer 320 and the HDD 390 of FIG. 2. A PVR processor 230 shown in FIG. 3 performs some operations of the controller 140 shown in FIG. 4, and partially corresponds to the PVR application 342 and the interface section 330 of FIG. 2.

As shown in FIG. 3, the TSD 210 analyzes a received broadcasting stream and differentially outputs streams used for channel information analysis, reproduction, storage, etc. The DDR buffer 220 stores the data stream output from the TSD 210. The data stream stored in the DDR buffer 220 may be stored at the same speed as the actual speed of receiving the broadcasting stream. Further, the size of the DDR buffer 220 may be determined based on the settings of the broadcasting signal receiving apparatus, and may be set in consideration of the number of receivable broadcasting channels, the format, the size, etc., of the broadcasting signal to be received. When the data stream is stored in the DDR buffer 220, the PVR processor 230 reads the stream from the DDR buffer 220 and stores the stream in the HDD 290 immediately or after a predetermined period of time. The PVR processor 230 may perform reading from the DDR buffer 220.

FIG. 4 shows an example in which the stream is stored in the storage device according to an exemplary embodiment. As shown in FIG. 4, when a broadcasting program is recorded while being viewed, time of storing the stream may be separated from time of processing the stream. For example, if a broadcasting program is recorded while being viewed, the stream is directly stored in the HDD 490 without conversion, the stored stream is converted after the recording, and the converted stream is stored again. Specifically, when the broadcasting program is recorded, the stream is directly stored without undergoing conversion or index-extraction. Subsequently, the stream undergoes conversion and index-extraction before being stored again, thereby advantageously reducing additional loads during the recording operation and efficiently storing the stream.

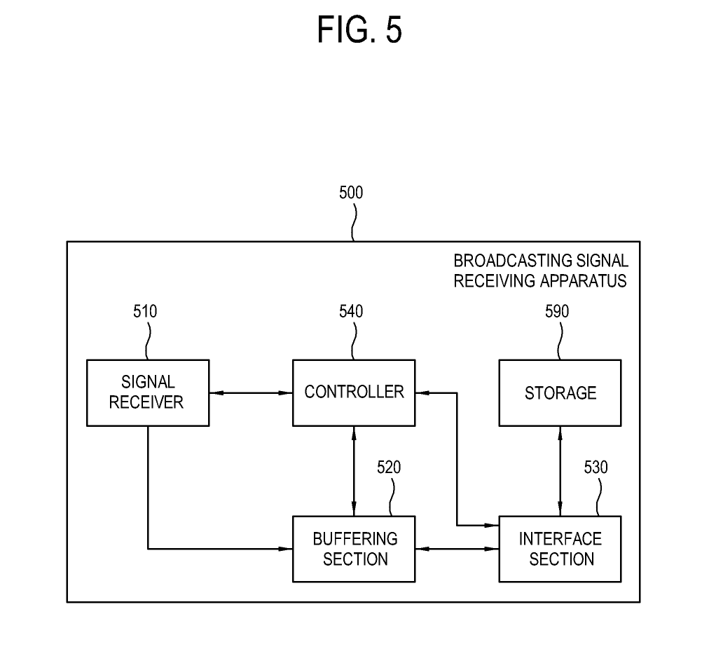

Below, elements of the broadcasting signal receiving apparatus 500 according to an exemplary embodiment will be described in detail with reference to FIG. 5, and repetitive descriptions to those described in FIGS. 1 to 4 will be omitted. FIG. 5 is a block diagram of a broadcasting signal receiving apparatus 500 according to an exemplary embodiment.

As shown in FIG. 5, the broadcasting signal receiving apparatus 500 includes a signal receiver 510, a buffering section 520 (e.g., buffer), an interface section 530 (e.g., interface), a controller 540, and a storage 590. The broadcasting signal receiving apparatus 500 may for example be achieved by a personal video recorder (PVR), a television (TV), a personal computer (PC), a notebook computer, a tablet, or the like capable of recording a broadcast corresponding to a predetermined period of time. The storage 590 may for example be achieved by a hard disk drive (HDD) provided in the broadcasting signal receiving apparatus 500.

The signal receiver 510 receives a broadcasting signal including a stream of data for displaying an image, and the buffering section 520 stores the stream included in the received broadcasting signal. The controller 540 receives storage information about the stream from the buffering section 520, and controls the interface section 530 to receive the stream from the buffering section 520 based on the received storage information and store the stream in the storage 590. The controller 540 may convert the stream stored in the storage 590 and stores the converted stream again. Further, the controller 540 may extract an index from the stream stored in the storage 590 and then store the stream again.

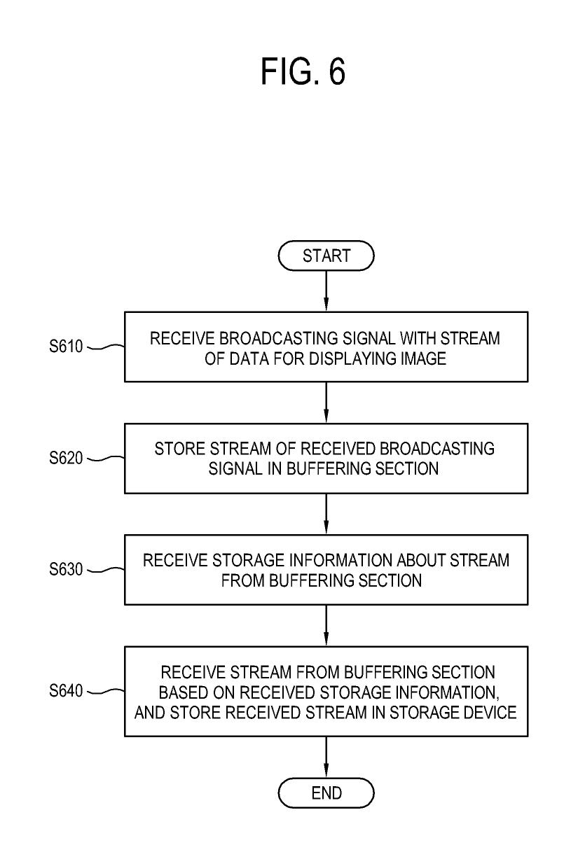

FIG. 6 is a flowchart showing a method of controlling the broadcasting signal receiving apparatus according to an exemplary embodiment.

As shown in FIG. 6, a broadcasting signal including a stream of data for displaying an image is received in operation S610, and the stream of the received broadcasting signal is stored in the buffering section in operation S620. The operation S620 of storing the stream in the buffering section may include an operation of storing the stream of the received broadcasting signal in real time. In this case, the size of the buffering section may be variable. For example, the size of the buffering section may be set in consideration of the number of receivable broadcasting channels, the format and the size of the broadcasting signal, etc. The operation S620 may further include storing the stream of the received broadcasting signal in the buffering section 120 according to a plurality of channels. That is, the broadcasting signal may be stored by respectively assigning a plurality of buffers to a plurality of channels.

In operation S630, the storage information about the stream is received from the buffering section. The storage information may include at least one of the size and the storing location of the stream stored in the buffering section 120. In operation S640, based on the received storage information, the stream is received from the buffering section and stored in the storage device. In addition, the operation S640 of storing the stream in the storage device may be at least partially implemented by a TSD application and a PVR application. According to an exemplary embodiment, as shown in FIG. 2, the TSD application may be requested by the PVR application to receive the storage information about the stream from the DDR buffer, where the broadcasting stream is stored in real time, and then transmit the storage information to the PVR application. The PVR application may control the stored stream to be stored in the HDD, based on the storage information about the stream received from the DDR buffer through the TSD application.

According to an exemplary embodiment, when predetermined units of the stream are completely stored in the buffering section, there may be further provided an operation of receiving the stream stored in the buffering section. For example, if the buffering section starts to record predetermined units of stream data to store the stream of the broadcasting signal, the stream stored in the buffering section may be receivable immediately or after a predetermined period of time.

The operation S640 of storing the stream in the storage device may include interfacing with the storage device according to at least one of USB, SATA, PCIe, etc. The operation S640 of storing the stream in the storage device may further include interfacing the buffering section and the storage device, and performing an interfacing operation to receive the stream stored in the buffering section and store the received stream in the storage device.

The operation S640 of storing the stream in the storage device may additionally include converting the stream stored in the storage device and storing the converted stream again, and extracting an index from the stream stored in the storage device and storing the index-extracted stream again. For example, as shown in FIG. 4, while the stream stored in the buffering section is received and stored in the HDD 490, i.e., the storage device, the stream may be stored without undergoing converting, indexing, and the like processes, and then after being completely stored (e.g., immediately after being completely stored), the stream may be converted into a format in which additional information is included or attached and then stored again in the storage device. Further, an index may be extracted from the stored stream after being completely stored, and then the index-extracted stream may be stored again. Specifically, when a broadcasting program is recorded while being viewed, the stream may be stored without conversion, and the original stream stored without conversion may be read to undergo the conversion and the index extraction after the recording is completed. Such a converted and index-extracted stream may be stored again in the HDD 490, and then the previously stored original stream may be deleted. Thus, when the broadcasting program is recorded while being viewed, the time of storing the stream is separated from the time of processing the stream, thereby reducing additional loads during the recording process and efficiently storing the stream.

As described above, according to an exemplary embodiment, there is provided a broadcasting signal receiving apparatus and a control method of the same, which can store a stream of a received broadcasting signal in a buffering section, and control an interface section so that the stored stream can be received based on the storage information received from the buffering section and stored in a storage device, thereby offering an efficient system where a memory space for storing the stream is minimized and the stream of the broadcasting signal is stored using a simple algorithm.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, it is understood that in exemplary embodiments, one or more components of the above-described apparatuses 100, 500 can include circuitry, a processor, a microprocessor, etc., and may execute a computer program stored in a computer-readable medium.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcasting signal receiving apparatus comprising:
a signal receiver configured to receive a broadcasting signal comprising a stream of data for displaying an image;
a buffer configured to store the stream comprised in the received broadcasting signal;
an interface configured to interface the buffer and a storage device comprising a storage space for reproducing the stream; and
a controller configured to control the interface to receive, from the buffer, storage information about the stored stream, to receive, from the buffer, the stored stream based on the received storage information, and to store the received stream in the storage device.

2. The broadcasting signal receiving apparatus according to claim 1, wherein the storage information comprises at least one of a size of the stream stored in the buffer and a storing location of the stream stored in the buffer.

3. The broadcasting signal receiving apparatus according to claim 1, wherein the controller comprises at least portions of a transport stream demultiplexer (TSD) application and a personal video recorder (PVR) application.

4. The broadcasting signal receiving apparatus according to claim 1, wherein the buffer is configured to store the stream of the received broadcasting signal in real time.

5. The broadcasting signal receiving apparatus according to claim 1, wherein the buffer is set to have a variable size.

6. The broadcasting signal receiving apparatus according to claim 1, wherein the controller is configured to control the interface to receive the stream stored in the buffer in response to predetermined units of the stream being completely stored in the buffer.

7. The broadcasting signal receiving apparatus according to claim 1, wherein the interface is configured to interface with the storage device according to at least one of universal serial bus (USB), serial advanced technology attachment (SATA), and peripheral component interconnect-express (PCIe).

8. The broadcasting signal receiving apparatus according to claim 1, wherein the controller is configured to convert the stream stored in the storage device and to store the converted stream.

9. The broadcasting signal receiving apparatus according to claim 1, wherein the controller is configured to extract an index from the stream stored in the storage device, and to store the index-extracted stream.

10. The broadcasting signal receiving apparatus according to claim 1, wherein the buffer is configured to store a plurality of streams of the received broadcasting signal in accordance with a plurality of channels, respectively.

11. A method of controlling a broadcasting signal receiving apparatus, the method comprising:
receiving a broadcasting signal comprising a stream of data for displaying an image;
storing, in a buffer, the stream comprised in the received broadcasting signal;
receiving, from the buffer, storage information about the stored stream;
receiving, from the buffer, the stored stream based on the received storage information; and
storing the received stream in a storage device.

12. The method according to claim 11, wherein the storage information comprises at least one of a size of the stream stored in the buffer and a storing location of the stream stored in the buffer.

13. The method according to claim 11, wherein the storing the received stream in the storage device comprises storing, by at least portions of a transport stream demultiplexer (TSD) application and a personal video recorder (PVR) application, the received stream in the storage device.

14. The method according to claim 11, wherein the storing the stream in the buffer comprises storing the stream of the received broadcasting signal in real time.

15. The method according to claim 11, wherein the buffer is set to have a variable size.

16. The method according to claim 11, wherein the receiving the stored stream comprises receiving, from the buffer, the stored stream in response to predetermined units of the stream being completely stored in the buffer.

17. The method according to claim 11, wherein the storing the received stream in the storage device comprises interfacing with the storage device according to at least one of universal serial bus (USB), serial advanced technology attachment (SATA), and peripheral component interconnect-express (PCIe).

18. The method according to claim 11, further comprising converting the stream stored in the storage device and storing, in the storage device, the converted stream.

19. The method according to claim 11, further comprising extracting an index from the stream stored in the storage device, and storing, in the storage device, the index-extracted stream.

20. The method according to claim 11, further comprising storing a plurality of streams of the received broadcasting signal in accordance with a plurality of channels, respectively.

21. A non-transitory computer readable recording medium having recorded thereon a program executable by a computer for performing the method of claim 11.

22. A broadcasting signal receiving apparatus comprising:
a signal receiver configured to receive a broadcasting signal comprising a stream of data for displaying an image;
a buffer configured to store the stream comprised in the received broadcasting signal; and
a controller configured to control receiving, from the buffer, storage information about the stored stream, receiving, from the buffer, the stored stream based on the received storage information, and storing the received stream in the storage device.

23. The broadcasting signal receiving apparatus according to claim 22, wherein the storage information comprises at least one of a size of the stream stored in the buffer and a storing location of the stream stored in the buffer.

24. The broadcasting signal receiving apparatus according to claim 22, wherein the controller comprises at least portions of a transport stream demultiplexer (TSD) application and a personal video recorder (PVR) application.

25. The broadcasting signal receiving apparatus according to claim 22, wherein the buffer is configured to store the stream of the received broadcasting signal in real time.

26. The broadcasting signal receiving apparatus according to claim 22, wherein the buffer is set to have a variable size.

27. The broadcasting signal receiving apparatus according to claim 22, wherein the controller is configured to control receiving the stream stored in the buffer in response to predetermined units of the stream being completely stored in the buffer.

28. The broadcasting signal receiving apparatus according to claim 22, wherein the controller is configured to convert the stream stored in the storage device and to store the converted stream.

29. The broadcasting signal receiving apparatus according to claim 22, wherein the controller is configured to extract an index from the stream stored in the storage device, and to store the index-extracted stream.

30. The broadcasting signal receiving apparatus according to claim 22, wherein the buffer is configured to store a plurality of streams of the received broadcasting signal in accordance with a plurality of channels, respectively.
